(19) United States
(12) Patent Application Publication
(10) Pub. No.: US 2022/0180195 A1
(43) Pub. Date: Jun. 9, 2022

(54) MODEL GENERATION DEVICE, MODEL ADJUSTMENT DEVICE, MODEL GENERATION METHOD, MODEL ADJUSTMENT METHOD, AND RECORDING MEDIUM

(71) Applicant: NEC Corporation, Minato-ku, Tokyo (JP)

(72) Inventors: Azusa SAWADA, Tokyo (JP); Takashi SHIBATA, Tokyo (JP)

(73) Assignee: NEC Corporation, Minato-ku, Tokyo (JP)

(21) Appl. No.: 17/598,422

(22) PCT Filed: Jun. 25, 2019
(86) PCT No.: PCT/JP2019/025113

§ 371 Date: Sep. 27, 2021

(30) Foreign Application Priority Data
Mar. 29, 2019 (JP) PCT/JP2019/013974

(51) Int. Cl. G06N 3/08; G06N 3/04; G06K 9/62

(52) U.S. Cl. CPC G06N 3/08; G06K 9/6256; G06N 3/0454

(57) ABSTRACT

The model generation device generates model parameters corresponding to the model to be used and mediation parameter relevance information indicating the relevance between the model parameters of a plurality of source domains and the mediation parameters by using the learning data in the plurality of source domains. The model adjustment device generates target model parameters which correspond to the target domain and include the mediation parameters, based on the learned model parameters for each of the plurality of source domains and the mediation parameter relevance information. Then, the model adjustment device uses the evaluation data of the target domain to determine the mediation parameters included in the target model parameters.

### TECHNICAL FIELD

The present invention relates to domain adaptation of recognition models.

### BACKGROUND ART

In various tasks, it is known that the performance of the recognition model using a neural network is good. However, since the model has flexibility, it also conforms to the surface characteristics of the learning data, and when the model is diverted to different data, its performance deteriorates. Therefore, a learning technique for obtaining good performance in the objective data characteristics (target domain) has been developed. This technique is also called “domain adaptation”. Specifically, a method is known in which a model learned in the source domain is additionally learned using the learning data in the target domain. For example, Patent Reference 1 describes a technique for correcting and interpolating the parameters of a model obtained by learning data of a first domain using the parameters obtained by learning in a second domain.

### PRECEDING TECHNICAL REFERENCE

### Patent Reference

Patent Reference 1: Japanese Patent Application Laid-open under No. JP 2018-180045

### SUMMARY OF INVENTION

### Problem to be Solved by the Invention

However, by the above technique, it is difficult to carry out domain adaptation in a place where sufficient learning data and calculation environment for the target domain cannot be obtained.

It is an example object of the present invention to enable the generation of a model adapted to a target domain even if there is only a limited amount of data for the target domain.

### Means for Solving the Problem

According to an example aspect of the present invention, there is provided a model generation device comprising:

a learning unit configured to learn model parameters corresponding to a model to be used using learning data in a plurality of source domains; and

a relevance information generation unit configured to generate mediation parameter relevance information indicating relevance between the model parameters and mediation parameters.

According to another example aspect of the present invention, there is provided a model adjustment device comprising:

a target model parameter generation unit configured to generate target model parameters which correspond to a target domain and include mediation parameters, based on learned model parameters for each of a plurality of source domains and mediation parameter relevance information indicating relevance between the learned model parameters and the mediation parameters; and

a determination unit configured to determine the mediation parameters included in the target model parameters using evaluation data of the target domain.

According to another example aspect of the present invention, there is provided a model generation method comprising:

learning model parameters corresponding to a model to be used using learning data in a plurality of source domains; and

generating mediation parameter relevance information indicating relevance between the model parameters and mediation parameters.

According to another example aspect of the present invention, there is provided a model adjustment method comprising:

generating target model parameters which correspond to a target domain and include mediation parameters, based on learned model parameters for each of a plurality of source domains and mediation parameter relevance information indicating relevance between the learned model parameters and the mediation parameters; and

determining the mediation parameters included in the target model parameters using evaluation data of the target domain.

According to another example aspect of the present invention, there is provided a recording medium storing a program causing a computer to execute processing of:

learning model parameters corresponding to a model to be used using learning data in a plurality of source domains; and

generating mediation parameter relevance information indicating relevance between the model parameters and mediation parameters.

According to another example aspect of the present invention, there is provided a recording medium storing a program causing a computer to execute processing of:

generating target model parameters which correspond to a target domain and include mediation parameters, based on learned model parameters for each of a plurality of source domains and mediation parameter relevance information indicating relevance between the learned model parameters and the mediation parameters; and

determining the mediation parameters included in the target model parameters using evaluation data of the target domain.

### Effect of the Invention

According to the present invention, by determining mediation parameters using the data of the target domain, it is possible to obtain a model adapted to the target domain.

### BRIEF DESCRIPTION OF THE DRAWINGS

FIG. 1 schematically shows a basic principle of domain adaptation according to the example embodiments.

FIG. 2 is a block diagram showing a hardware configuration of a model generation device according to a first example embodiment.

FIG. 3 is a block diagram showing a functional configuration of the model generation device.

FIG. 4 is a flowchart of model generation processing.

FIG. 5 is a block diagram showing a hardware configuration of a model adjustment device according to the first example embodiment.

FIG. 6 is a block diagram showing a functional configuration of the model adjustment device.

FIG. 7 is a flowchart of model adjustment processing.

FIG. 8 schematically shows the relevance of mediation parameters according to the first example of the model generation processing.

FIG. 9 is a configuration example of a learning model according to the second example

FIG. 10A and 10B are other configuration examples of the learning model according to the second example.

FIG. 11A and 11B are block diagrams showing functional configurations of a model generation device and a model adjustment device according to a second example embodiment.

### EXAMPLE EMBODIMENTS

Preferred example embodiments of the present invention will be described below with reference to the accompanying drawings.

### Basic Principle

First, the basic principle of domain adaptation according to the example embodiments will be described. The example embodiments are characterized in that domain adaptation is performed using evaluation data of a limited amount in the target domain. Here, the “domain” is a region of data defined by conditions such as a place where data is obtained, a time when the data is obtained, and an environment where the data is obtained. The data for which these conditions are common is the data of the same domain. For example, even if image data are taken at the same location, if the times are different or the camera characteristics are different, those image data are the data of different domains. Further, even if the image data are taken by the same camera at the same location, if the image-taking conditions such as the scale ratio of the taken image, the illumination conditions, the camera orientation, the camera angle of view, or the like are different, those image data are the data of different domains. In the following description, a domain used for learning a model is called a “source domain,” and a domain to which the model obtained by the learning is applied is called a “target domain.”

The domain adaptation according to the example embodiments are basically performed by a model generation device and a model adjustment device. The model generation device generates parameters of the model for each source domain (hereinafter referred to as “model parameters”) and mediation parameter relevance information using learning data of a plurality of source domains. On the other hand, the model adjustment device generates parameters of the model adapted to the target domain using the model parameters and the mediation parameter relevance information generated by the model generation device, and evaluation data of the target domain.

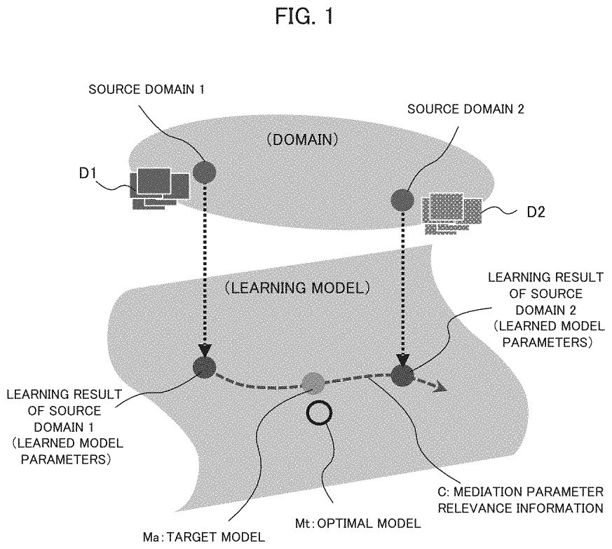

FIG. 1 schematically shows the basic principle of domain adaptation according to the example embodiments. In the example embodiments, it is assumed that the model generation device generates a recognition model that is used in the processing of recognizing objects from the image data. Also, it is assumed that the recognition model is a model using a neural network. Now, as illustrated, there are source domains 1 and 2. The learning data D1 are prepared for the source domain 1, and the learning data D2 are prepared for the source domain 2. The model generation device performs learning of a learning model using the learning data D1 for the source domain 1, and generates the learning result. In addition, the model generation device performs learning of a learning model using the learning data D2 for the source domain 2, and generates the learning result. Incidentally, those learning results are a set of parameters (weights) in the neural network constituting the learning model, which will be hereinafter also referred to as “learned model parameters”.

Now, we consider generating the model parameters for a target domain which is different from the source domains 1 and 2. If there are sufficient learning data for the target domain, it is possible to use them to learn the model. However, in this case, it is assumed that only a limited amount of data, specifically evaluation data, can be obtained for the target domain. In this case, in the example embodiments, mediation parameters corresponding to the difference in domains are introduced. The mediation parameters are parameters that have a role to mediate the model parameters corresponding to different source domains and have relevance to the model parameters of different source domains.

The mediation parameters are defined based on the learning results of the source domains 1 and 2, and are conceptually given by the curve C connecting the learning results of the source domains 1 and 2 as shown in FIG. 1. The values of the mediation parameters designate the position on the curve C. By changing the values of the mediation parameters, the model parameters move on the curve C between the learned model parameters of the source domain 1 and the learned model parameters of the source domain 2 This curve C represents information indicating the relevance between the mediation parameters and the learned model parameters for each source domain (hereinafter referred to as “mediation parameter relevance information”). The model generation device uses the learned model parameters of the source domain 1, the learned model parameters of the source domain 2 and the learning data D1, D2 of the source domains 1 and 2 to generate the mediation parameter relevance information which indicates how to deform the model parameters by the values of the mediation parameters. Then, the model generation device generates a parameter set including the learned model parameters for each source domain and the mediation parameter relevance information. This parameter set is created such that the model parameters can be adapted to the target domain by adjusting the mediation parameters.

Next, we consider adjusting the model parameters of the target domain using the evaluation data of a certain target domain. In this case, the model adjustment device first generates a model of the target domain (hereinafter referred to as “target model”) using the learned model parameters for each source domain and the mediation parameter relevance information. In one example, the model adjustment device generates the target model by reflecting the mediation parameters to the learned model parameters of the source domain closest to the target domain among the plurality of source domains. In another example, the model adjustment device generates the target model by reflecting the mediation parameters to the learned model parameters of a predetermined one of the plurality of source domains. In yet another example, the model adjustment device generates the target model by reflecting the mediation parameters to the learned model parameters of some or all of the plurality of source domains.

Next, the model adjustment device performs the performance evaluation using the evaluation data of the target domain while changing the values of the mediation parameters. In other words, the model adjustment device uses the evaluation data of the target domain to search for the mediation parameters adapted to the target domain. Then, the values of the mediation parameters when the best performance is obtained are determined as the values of the mediation parameters adapted to the target domain, and the values are applied to the mediation parameters of the target model.

In FIG. 1, when it is assumed that sufficient learning data exists in the target domain, the model obtained by the learning using the sufficient learning data is represented by the “optimal model Mt.” In contrast, the target model adapted to the target domain by adjusting the mediation parameters according to the method of the example embodiments is represented by “Ma”. The target model Ma is determined at a position on the curve C representing the mediation parameter relevance information and sufficiently close to the optimal model Mt. Thus, although the method of the example embodiments cannot generate a model that coincides with the optimal model Mt, it is possible to obtain the target model Ma that is located on the curve C representing the mediation parameter relevance information and is closest to the optimal model Mt.

### First Example Embodiment

Next, a first example embodiment of the present invention will be described.

### Model Generation Device

First, a model generation device will be described in detail.

### Hardware Configuration

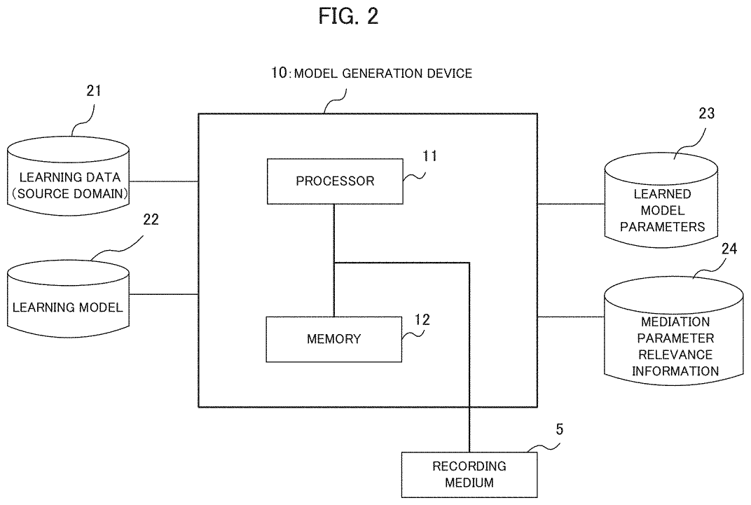

FIG. 2 is a block diagram showing a hardware configuration of a model generation device according to the first example embodiment. The model generation device 10 is configured using a computer, and uses the learning data of the plurality of source domains to learn the parameters of the recognition model to be used.

As shown in FIG. 2, the model generation device 10 includes a processor 11 and a memory 12. The processor 11 includes a CPU, or a CPU and a GPU, and executes model generation processing by executing a program prepared in advance. The memory 12 is constituted by a RAM (Random Access Memory), a ROM (Read Only Memory), or the like, and stores programs executed by the processor 11. The memory 12 also functions as a work memory during execution of processing by the processor 11.

The model generation device 10 is capable of reading the recording medium 5. The recording medium 5 records a program to execute a model generation processing. The recording medium 5 is a non-transitory recording medium, such as a non-volatile recording medium, which can be read by a computer. Examples of the recording medium 5 include a magnetic recording device, an optical disk, a magneto-optical recording medium, and a semiconductor memory. The program recorded on the recording medium 5 is read into the memory 12 and executed by the processor 11 at the time of executing the processing by the model generation device 10.

To the model generation device 10, the learning data 21 and the learning model 22 are inputted. The learning data 21 is a group of image data prepared in a plurality of source domains. The learning model 22 is an identification model prepared in advance to perform the recognition processing of objects. The model generation device 10 executes model generation processing using the learning data 21 and the learning model 22, and outputs the learned model parameters 23 and the mediation parameter relevance information 24. The learned model parameters 23 are generated for each of a plurality of source domains. The mediation parameters are parameters which correspond to the differences between different source domains, details of which will be described later.

### Functional Configuration

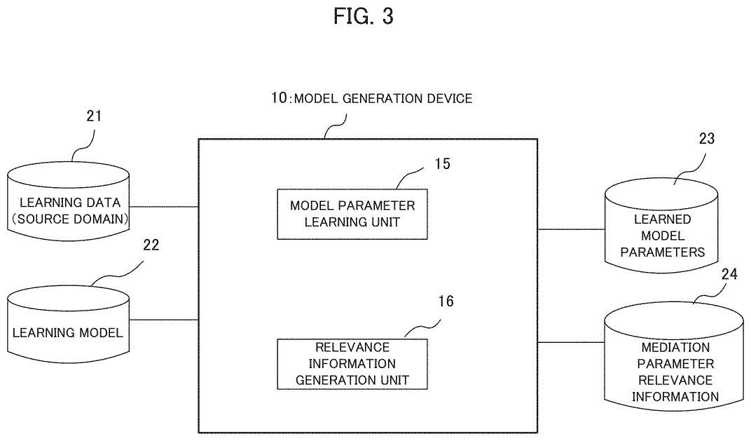

Next, the functional configuration of the model generation device 10 will be described. FIG. 3 is a block diagram showing a functional configuration of the model generation device 10. As illustrated, the model generation device 10 functionally includes a model parameter learning unit 15 and a relevance information generation unit 16.

The model parameter learning unit 15 learns the model parameters which are the parameters of the learning model for each of the plurality of source domains, and generates the learned model parameters 23 for each source domain. Now, assuming that there are learning data for the source domains 0 to 2 as the learning data 21, the model parameter learning unit 15 performs learning of the learning model using the learning data of the source domain 0 and generates the learned model parameters of the source domain 0. It is noted that the learned model parameters are a set of weights in the neural network constituting the recognition model. Also, the model parameter learning unit 15 performs learning of the learning model using the learning data of the source domain 1, and generates the learned model parameters of the source domain 1. Further, the model parameter learning unit 15 performs learning of the learning model using the learning data of the source domain 2, and generates the learned model parameters of the source domain 2. Then, the model parameter learning unit 15 outputs the learned model parameters 23 of the source domains 0 to 2. The model parameter learning unit 15 is an example of a learning unit of the present invention.

The relevance information generation unit 16 generates the mediation parameter relevance information 24 indicating the relevance between the learned model parameters and the mediation parameters using the learning data of the plurality of source domains and the learned model parameters for each source domain generated by the model parameter learning unit 15. Here, the “relevance” indicates how to deform the model parameters according to the values of the mediation parameters. Incidentally, the relevance information generation unit 16 performs the generation of the mediation parameter relevance information separately from the learning of the model parameters by the model parameter learning unit 15.

### Model Generation Processing

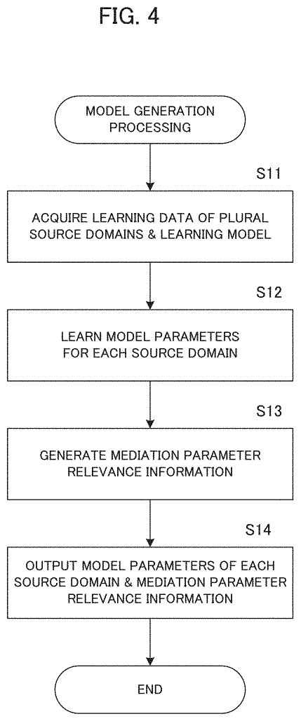

Next, model generation processing executed by the model generation device 10 will be described. FIG. 4 is a flowchart of the model generation processing. This processing is executed by the processor 11 shown in FIG. 2, which executes a program prepared in advance.

First, the model generation device 10 acquires the learning data 21 of the plurality of source domains, and the learning model 22 (Step S11). Next, the model generation device 10 learns the model parameters for each source domain by the model parameter learning unit 15 using the learning data for each source domain (Step S12).

Next, the model generation device 10 generates, by the relevance information generation unit 16, the mediation parameter relevance information 24 indicating the relevance between the learned model parameters and the mediation parameters based on the learning data of the plurality of source domains and the learned model parameters for each source domain obtained in Step S12 (Step S13). Then, the model generation device 10 outputs the learned model parameters 23 for each source domain obtained in Step S12 and the mediation parameter relevance information 24 obtained in Step S13 (Step S14). Then, the processing ends.

### Model Adjustment Device

Next, the model adjustment device will be described in detail.

### Hardware Configuration

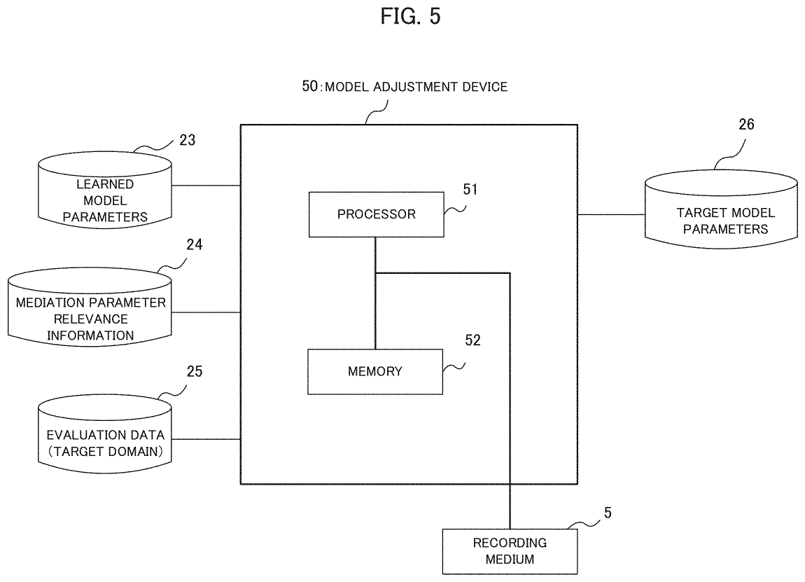

FIG. 5 is a block diagram showing a hardware configuration of a model adjustment device according to the first example embodiment. The model adjustment device 50 is configured by a computer. The model adjustment device 50 generates parameters (hereinafter, also referred to as “target model parameters”) of the recognition model adapted to the target domain (hereinafter, also referred to as “target model”) using the learned model parameters for each source domain and the mediation parameter relevance information generated by the model generation device 10.

As shown in FIG. 5, the model adjustment device 50 includes a processor 51 and a memory 52. The processor 51 includes a CPU, or a CPU and a GPU, and executes the model adjustment processing by executing a program prepared in advance. The memory 52 is constituted by a RAM, a ROM, or the like, and stores programs executed by the processor 51. The memory 52 also functions as a work memory during the execution of the processing by the processor 51.

Also, the model adjustment device 50 is capable of reading the recording medium 5. The recording medium 5 records a program for executing the model adjustment processing. Examples of the recording medium 5 are the same as those in the case of the model generation device 10. The program recorded on the recording medium 5 is read into the memory 52 and executed by the processor 51 at the time of executing the processing by the model adjustment device 50.

To the model adjustment device 50, the learned model parameters 23, the mediation parameter relevance information 24, and evaluation data 25 of the target domain are inputted. The learned model parameters 23 and the mediate parameter relevance information 24 are those generated by the model generation device 10 as described above. The evaluation data 25 are data obtained in the target domain. Incidentally, the target domain is a domain different from the source domains of the learning data 21 inputted to the model generation device 10 shown in FIG. 2, i.e., each source domain of the learned model parameter 23.

The model adjustment device 50 generates a target model corresponding to the target domain using the inputted data described above. Then, the model adjustment device 50 adjusts the mediation parameters included in the target model, and outputs the target model parameters 26 defined by the adjusted mediation parameters.

### Functional Configuration

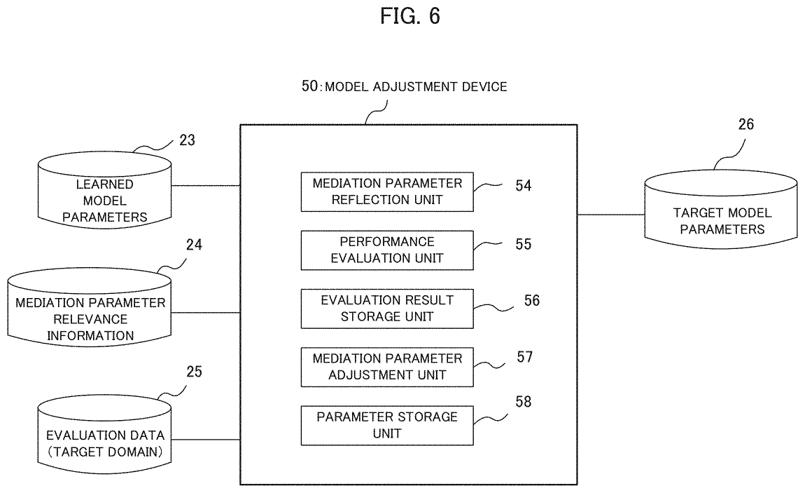

Next, the functional configuration of the model adjustment device 50 will be described. FIG. 6 is a block diagram showing the functional configuration of the model adjustment device 50. As shown, the model adjustment device 50 functionally includes a mediation parameter reflection unit 54, a performance evaluation unit 55, an evaluation result storage unit 56, a mediation parameter adjustment unit 57, and a parameter storage unit 58.

The mediation parameter reflecting unit 54 reflects the mediation parameters to the learned model parameters 23 based on the mediation parameter relevance information 24, and generates the target model including the mediation parameters. The performance evaluation unit 55 performs the performance evaluation of the target model generated by the mediation parameter reflection unit 54 using the evaluation data of the target domain. Here, the performance evaluation unit 55 performs the performance evaluation of the target model while changing the values of the mediation parameters in the target model including the mediation parameters. Specifically, the performance evaluation unit 55 performs the performance evaluation using a predetermined evaluation index for all the evaluation data of the target domain, while changing the values of the mediation parameters. Then, the performance evaluation unit 55 stores the obtained performance evaluation value in the evaluation result storage unit 56. For example, as the predetermined performance evaluation index, accuracy or AUCs (Area Under the Curve) of ROCs (Receiver Operating Characteristic) curves may be used for classification problems. If there are no labels for the evaluation data, the height of the indicator which corresponds to the confidence level of the model's prediction may be used. The mediation parameter reflecting unit 54 is an example of a target model parameter generation unit of the present invention.

The mediation parameter adjustment unit 57 refers to the performance evaluation result stored in the evaluation result storing unit 56, and determines the values of the mediation parameters when the best evaluation result is obtained as the values of the mediation parameters used for the target domain. Then, the mediation parameter adjustment unit 57 generates the target model including the mediation parameters of the determined values, stores the target model parameters 26 which are the parameters of the target model into the parameter storage unit 58, and outputs them to outside. The mediation parameter adjustment unit 57 is an example of a determination unit of the present invention.

### Model Adjustment Processing

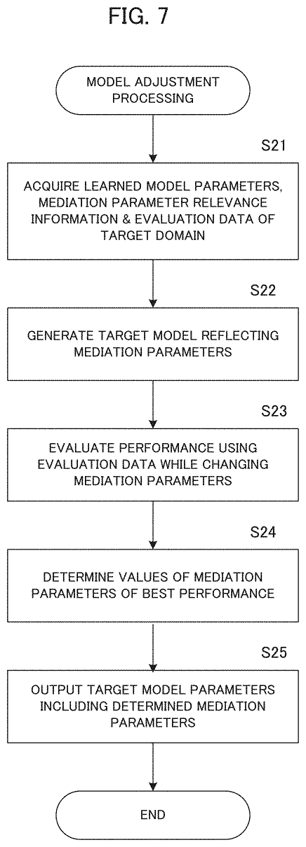

Next, model adjustment processing executed by the model adjustment device 50 will be described. FIG. 7 is a flowchart of the model adjustment processing. This processing is executed by the processor 51 shown in FIG. 5, which executes a program prepared in advance.

First, the model adjustment device 50 acquires the learned model parameters 23, the mediation parameter relevance information 24, and the evaluation data 25 of the target domain (Step S21). Next, the model adjustment device 50 generates, by the mediation parameter reflecting unit 54, the target model in which the mediation parameters are reflected (Step S22).

Next, the model adjustment device 50 performs, by the performance evaluation unit 55, the performance evaluation using the evaluation data while changing the mediation parameters (Step S23). Next, the mediation parameter adjustment unit 57 determines the values of the mediation parameters for which the performance evaluation result is best as the values of the mediation parameters for the target domain (Step S24). Then, the model adjustment device 50 outputs the target model parameters including the values of the determined mediation parameters (Step S25). Then, the processing ends.

### EXAMPLES

Next, examples of the model generation processing by the model generation device 10 will be described.

### First Example

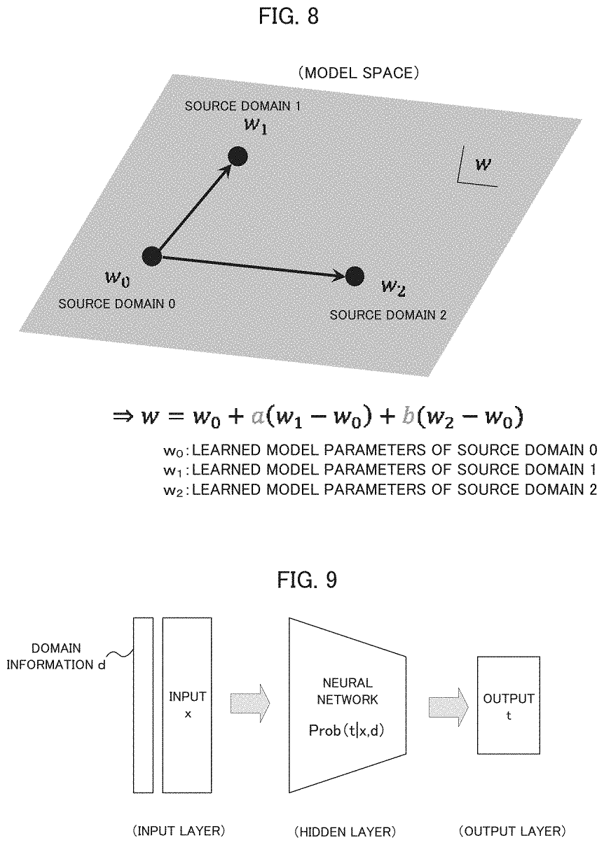

In the first example, the mediation parameter relevance information is represented using the differences of the learned model parameters of the plurality of source domains. FIG. 8 schematically shows the mediation parameter relevance information according to the first example of the model generation processing. FIG. 8 schematically shows a model space defined by the mediation parameters.

In the first example, one basic domain is determined from among a plurality of source domains. Since the basic domain is a standard domain among a plurality of source domains, it is preferable that the basic domain is the source domain whose characteristic is not extreme. In addition, the basic domain is preferably the source domain having the data set of the highest quality. As a specific example, among the plurality of source domains, the basic domain may be the one having the highest number of data, the one having the lowest data degradation, or the one having the lowest noise. This basic domain may be created by joining multiple source domains.

In the example of FIG. 8, there are three source domains 0 to 2. It is assumed that the basic domain is the source domain 0, and the learned model parameters of the source domain 0 are indicated by “w₀”. Similarly, it is assumed that the learned model parameters of source domain 1 are indicated by “w₁”, and the learned model parameters of source domain 2 are indicated by “w₂”. All of those learned model parameters w₀ to w₂ are generated by the model parameter learning unit 15 of the model generation device 10. Also, the model generated by the model generation device 10, i.e., the model represented by the model parameters including the mediation parameters, is indicated by “w.”

In the first example, the learning model w generated by the model generation device 10 is represented as a linear combination of the difference vectors between the learned model parameters of the basic domain and the learned model parameters of the other source domains. Specifically, the learning model w is given by the following equation.

w=w₀+a(w₁−w₀)+b(w₂−w₀) (1)

Here, “a” and “b” are the mediation parameters.

As described above, in the first example, the space defined by the difference vectors of the source domains with respect to the basic domain is considered, and the mediation parameters a and b are defined as the coefficients to be multiplied by the difference vectors (w₁−w₀), (w₂−w₀). Thus, the learning model w is shown in the model space defined by the two mediation parameters a, b, as shown in FIG. 8.

In the model adjustment processing by the model adjustment device 50, the mediation parameter adjustment unit 57 may search the values of the mediation parameters in the model space of the (the number of source domains—1) dimension (i.e., 2-dimensional in this example). Although two or more source domains are required to define the model space including the learning model w, if the number of source domains is too large, the search processing executed by the mediation parameter adjustment unit 57 in the model adjustment processing becomes enormous. Therefore, when the number of source domains is large, the number of source domains may be reduced to suppress the dimension of the model space. For example, from multiple source domains, several source domains considered useful may be selected, or several source domains may be selected using criteria such as major directions of change in parameter variations.

Conversely, if the number of source domains is small, the source domains may be increased by dividing the data set or data conversion processing. It is desirable that the data conversion processing ideally generates variation corresponding to the difference of domains. In the case of image recognition, rotation, scaling, blurring, or imparting noise can be used as the data conversion processing.

In the model generation processing, the model parameter learning unit 15 of the model generation device 10 learns the learned model parameters w₁ of the source domain 1 and the learned model parameters w₂ of the source domain 2 using the learned model parameters w₀ of the source domain 0 as an initial value. Then, the model parameter learning unit 15 outputs the model parameters w₀ to w₂ as the learned model parameters 23. The relevance information generation unit 16 outputs the equation (1) or information indicating that the mediation parameters a and b are the coefficients to be multiplied by the difference vectors (w₁−w₀), (w₂−w₀) as the mediation parameter relevance information 24. As the mediation parameter relevance information outputted at this time, in order to acquire the one suitable for the purpose of use for adjustment, the model parameter learning unit 15 may use a constraint to suppress the difference from the learned model parameters in other domains.

### Second Example

The second example defines the mediation parameters as variables inputted to the neural network constituting the learning model. FIG. 9 shows a configuration example of a learning model according to the second example In this example, the variables corresponding to the difference of the source domains are assumed to be the domain information d, and the domain information d is used as the input variable of the neural network. That is, in addition to the input x, the domain information d is inputted as the input variables to the input layer of the neural network. As the domain information d, conditions which are different in each source domain, e.g., the scale ratio, the color temperature, or the angle of the camera of the image data can be used.

For example, it is assumed that there are three source domains wherein the scale ratios of the images are “1,” “2,” and “5,” respectively. In this case, in the model generation processing, the value of each scale ratio is inputted as the domain information d, and the model generation device 10 performs learning using the learning data of each source domain. Thus, the learning model having the mediation parameters as the domain information d is generated.

Other than using the domain information of the source domain, when the domain is increased by dividing the data set or by the data conversion processing, the condition at that time may be used as the domain information. It is desirable that the data conversion processing ideally generates variations corresponding to the difference in domains. In the case of image recognition, rotation, scaling, bluffing, or noise imparting can be used as the data conversion processing.

In this case, the model parameter learning unit 15 of the model generation device 10 outputs the parameter set of the neural network and the domain information d as the learned model parameters 23. Also, the relevance information generation unit 16 outputs the input position of the domain information d to the neural network, e.g., information indicating the input layer, or the number of layers of the hidden layer, as the mediation parameter relevance information 24.

On the other hand, in the model adjustment processing, the model adjustment device 50 performs the performance evaluation of the target model using the evaluation data of the target domain while changing the domain information d serving as the mediation parameter, i.e., the scale ratio of the images. Then, the model adjustment device 50 uses the value of the mediation parameter, i.e., the scale ratio of the image when the best performance is obtained, to determine the target model. For example, in a case where the scale ratio of the images in the target domain is unknown but the best performance is obtained when the scale of the images is “3” by the performance evaluation performed using the evaluation data, the value of the mediation parameter in the target model is determined to be “3”.

Incidentally, when the domain information d in the target domain (the scale ratio of the images in the above example) is known, that value may be used as the mediation parameter. For example, if the scale ratio of the images in the target domain is known to be “2” in the above example, that is, if the domain information d in the target domain coincides with the domain information d of any of the source domains, it is possible to omit the processing of searching the mediation parameter while changing the mediation parameter in the model adjustment processing. In this case, the model adjustment device 50 may determine the value of the mediation parameter to “2” in the target model generated by the mediation parameter reflecting unit 54.

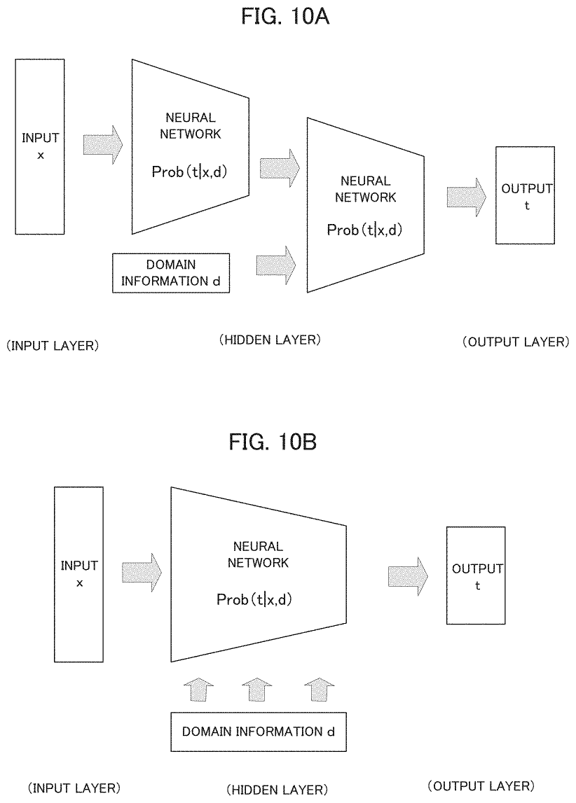

FIGS. 10A and 10B illustrate other examples of a learning model according to a second example In the example of FIG. 9, the domain information d is inputted to the input layer of the neural network. Instead, the domain information d may be inputted to the hidden layer of the neural network, as shown in FIGS. 10A and 10B. For example, as shown in FIG. 10A, the domain information d may be inputted to one position of the hidden layer. Also, as shown in FIG. 10B, the domain information d may be inputted to multiple positions of the neural network.

### Third Example

The third example selects one model parameter from a plurality of model parameter candidates based on the performance in the evaluation data of the target domain by using the mediation parameter relevance information as a dictionary of the learning results of the plurality of domains. This is a special case of other examples and can be considered to be that the mediation parameters are discrete values that do not continuously fill the model space. Since the model parameter learning unit 15 at this time does not need to suppress the difference from the learned model parameters in the other domains, each learning may be performed independently.

The source domain may be enhanced to increase the number of model parameter candidates so that the mediate parameter relevance information 24 includes the model parameter candidates effective for more target domains For example, it is possible to artificially enhance the source domain by dividing the data set or by the data conversion processing. It is desirable that the data conversion processing ideally generates variations corresponding to the difference in domains. In the case of image recognition, rotation, scaling, blurring, or imparting noise can be used as the data conversion processing. In addition, when the model parameters differ dependently upon the random number at the time of learning, one created by a plurality of random number seeds may be held as the candidate. Particularly, since the domain in which peak performance is obtained is different between the model parameters learned in the domains made by combining multiple source domains and the model parameters learned in each original source domain, both model parameters can be included in the model parameter candidates so that the adaptable range with good performance can be expanded.

The candidates of feature extractors acquired as a part of the model or by metric learning or the like may be generated and selected. Particularly, in the model generation of only the feature extractor, other than the division of the data set and the data conversion processing, the domain can be increased in the following manner. That is, in a multi-label data set such as attribute estimation, multiple data sets of the same data but different tasks can be created by using only a part of the labels for learning and changing the combination of the used labels. By using such a data set for learning, the model parameter candidates can be increased.

### Effects by the Example Embodiment

As described above, according to the present example embodiment, the model adjustment device 50 may perform the performance evaluation using the evaluation data set to determine appropriate mediation parameters. Therefore, it is not necessary to prepare a large amount of data in the target domain as learning data, and domain adaptation is possible even if the amount of data obtained in the target domain is small.

Depending on the industry using the recognition model, there is such a case that confidentiality of data in the target domain is high and data cannot be given from companies. Even in such a case, according to the present example embodiment, the model generation processing may be executed using the learning data of the source domains to provide the result to the company. On the company side, the model adjustment processing described above can be executed using the data of the target domain concealed in the company to generate the target model. Incidentally, when the learning data of the source domains are generated by simulation, if the conditions that are likely to be used in the environment at the company side are predicted and the learning data in the corresponding source domains are generated, the model adjustment at the company side can be facilitated.

Also, in the present example embodiment, the model can be adapted to the target domain by adjusting the mediation parameters in the model adjustment processing. Therefore, it is possible to adjust the model using a small amount of data obtained in the target domain, not only when the data of the target domain is small or concealed, but also when the generated model is deployed.

### Second Example Embodiment

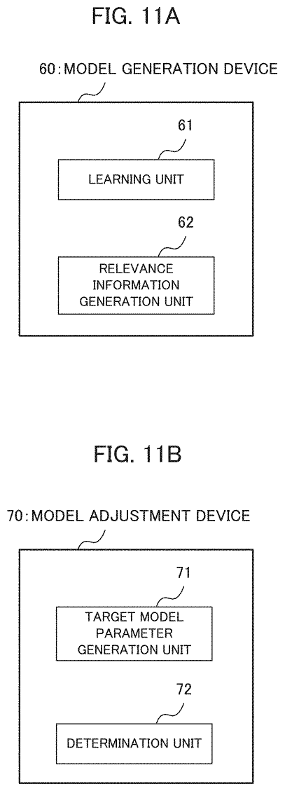

Next, a second example embodiment of the present invention will be described. FIG. 11A shows the functional configuration of a model generation device 60 according to the second example embodiment of the present invention. Incidentally, the hardware configuration of the model generation device 60 is the same as the model generation device 10 shown in FIG. 2. As shown in FIG. 11A, the model generation device 60 includes a learning unit 61 and a relevance information generation unit 62. The learning unit 61 learns the model parameters corresponding to the model to be used using the learning data in a plurality of source domains. The relevance information generation unit 62 generates the mediation parameter relevance information indicating the relevance between the model parameters of the plurality of source domains and the mediation parameters. In the model adjustment processing, the model adapted to the target domain can be obtained by adjusting the mediation parameters using the evaluation data of the target domain.

FIG. 11B shows the functional configuration of a model adjustment device according to the second example embodiment. The hardware configuration of the model adjustment device 70 is the same as the model adjustment device 50 shown in FIG. 5. As shown in FIG. 11B, the model adjustment device 70 includes a target model parameter generation unit 71 and a determining unit 72. The target model parameter generation unit 71 acquires the learned model parameters for each of the plurality of source domains, and the mediation parameter relevance information indicating the relevance between the learned model parameters of the plurality of source domains and the mediation parameters. Then, the target model parameter generation unit 71 generates target model parameters which correspond to the target domain and include the mediation parameters based on the learned model parameters for each of the plurality of source domains and the mediation parameter relevance information. The determination unit 72 determines the mediation parameters included in the target model parameters using the evaluation data of the target domain. Thus, it becomes possible to obtain the target model adapted to the target domain.

### Modification

In the above example embodiments, the model generation device and the model adjustment device are configured as a separate device. However, a single model generation device having both functions may be configured. Further, in the above example embodiments, the object of the processing by the model is the image data. However, this is only an example, and other various data may be used as the object of the processing by the model.

Some or all of the example embodiments described above may also be described as the following supplementary notes, but not limited thereto.

### Supplementary Note 1

A model generation device comprising:

a learning unit configured to learn model parameters corresponding to a model to be used using learning data in a plurality of source domains; and

a relevance information generation unit configured to generate mediation parameter relevance information indicating relevance between the model parameters and mediation parameters.

### Supplementary Note 2

The model generation device according to supplementary note 1,

wherein the learning unit generates learned model parameters for each source domain using the learning data in the plurality of source domains, and

wherein the relevance information generation unit generates the mediation parameter relevance information indicating the relevance between the mediation parameters and the learned model parameters for each source domain using the learned model parameters for each source domain.

### Supplementary Note 3

The model generation device according to supplementary note 1 or 2,

wherein the mediation parameter relevance information is indicated by a linear combination of difference vectors between the learned model parameters for each of the source domains, and wherein the mediation parameters are coefficients multiplied by the difference vectors.

### Supplementary Note 4

The model generation device according to supplementary note 3, wherein the difference vectors indicate differences between the learned model parameters of a basic domain which is one of the plurality of source domains and the learned model parameters of another source domain.

### Supplementary Note 5

The model generating device according to supplementary note 4, wherein the basic domain is the source domain including a largest number of learning data among the plurality of source domains.

### Supplementary Note 6

The model generation device according to supplementary note 1 or 2,

wherein the model is a neural network, and

wherein the mediation parameters are variables inputted to at least one position of an input layer or a hidden layer of the neural network.

### Supplementary Note 7

The model generation device according to supplementary note 2, further comprising an output unit configured to output the learned model parameters for each source domain and the mediation parameter relevance information.

### Supplementary Note 8

The model generation device according to supplementary note 2, further comprising:

a target model parameter generation unit configured to generate target model parameters which correspond to the target domain and include the mediation parameters, based on the plurality of learned model parameters for each source domain and the mediation parameter relevance information, and

a determination unit configured to determine the mediation parameters included in the target model parameters using the evaluation data of the target domain.

### Supplementary Note 9

The model generation device according to any one of supplementary notes 1 to 8, further comprising a data generation unit configured to divide the learning data of a certain source domain to generate the learning data in the plurality of source domains.

### Supplementary Note 10

The model generation device according to any one of supplementary notes 1 to 8, further comprising a data generation unit configured to apply data conversion processing to the learning data of a certain source domain to generate the learning data in the plurality of source domains.

### Supplementary Note 11

The model generation device according to supplementary note 10, wherein the data conversion processing generates variations corresponding to the difference in domains.

### Supplementary Note 12

A model adjustment device comprising:

a target model parameter generation unit configured to generate target model parameters which correspond to a target domain and include mediation parameters, based on learned model parameters for each of a plurality of source domains and mediation parameter relevance information indicating relevance between the learned model parameters and the mediation parameters; and

a determination unit configured to determine the mediation parameters included in the target model parameters using evaluation data of the target domain.

### Supplementary Note 13

The model adjustment device according to supplementary note 12, wherein the determination unit performs performance evaluation using the evaluation data while changing values of the mediation parameters, and determines the values of the mediation parameters when a result of the performance evaluation is best as the values of the mediation parameters included in the target model parameters.

### Supplementary Note 14

A model generation method comprising:

learning model parameters corresponding to a model to be used using learning data in a plurality of source domains; and

generating mediation parameter relevance information indicating relevance between the model parameters and mediation parameters.

### Supplementary Note 15

A model adjustment method comprising:

generating target model parameters which correspond to a target domain and include mediation parameters, based on learned model parameters for each of a plurality of source domains and mediation parameter relevance information indicating relevance between the learned model parameters and the mediation parameters; and

determining the mediation parameters included in the target model parameters using evaluation data of the target domain.

### Supplementary Note 16

A recording medium storing a program causing a computer to execute processing of:

learning model parameters corresponding to a model to be used using learning data in a plurality of source domains; and

generating mediation parameter relevance information indicating relevance between the model parameters and mediation parameters.

### Supplementary Note 17

A recording medium storing a program causing a computer to execute processing of:

generating target model parameters which correspond to a target domain and include mediation parameters, based on learned model parameters for each of a plurality of source domains and mediation parameter relevance information indicating relevance between the learned model parameters and the mediation parameters; and

determining the mediation parameters included in the target model parameters using evaluation data of the target domain.

While the present invention has been described with reference to the example embodiments and examples, the present invention is not limited to the above example embodiments and examples. Various changes which can be understood by those skilled in the art within the scope of the present invention can be made in the configuration and details of the present invention.

### DESCRIPTION OF SYMBOLS

10, 60 Model generation device
11, 51 Processor
12, 52 Memory
15 Model parameter learning unit
16 Relevance information generation unit
50, 70 Model adjustment device
54 Mediation parameter reflection unit
55 Performance evaluation unit
57 Mediation parameter adjustment unit

What is claimed is:

1. A model generation device comprising:
a memory storing instructions; and
one or more processors configured to execute the instructions to:
learn model parameters corresponding to a model to be used using learning data in a plurality of source domains; and
generate mediation parameter relevance information indicating relevance between the model parameters and mediation parameters.

2. The model generation device according to claim 1,
wherein the one or more processors are configured to generate learned model parameters for each source domain using the learning data in the plurality of source domains, and
wherein the one or more processors are configured to generate the mediation parameter relevance information indicating the relevance between the mediation parameters and the learned model parameters for each source domain using the learned model parameters for each source domain.

3. The model generation device according to claim 1,
wherein the mediation parameter relevance information is indicated by a linear combination of difference vectors between the learned model parameters for each of the source domains, and
wherein the mediation parameters are coefficients multiplied by the difference vectors.

4. The model generation device according to claim 3, wherein the difference vectors indicate differences between the learned model parameters of a basic domain which is one of the plurality of source domains and the learned model parameters of another source domain.

5. The model generating device according to claim 4, wherein the basic domain is the source domain including a largest number of learning data among the plurality of source domains.

6. The model generation device according to claim 1, wherein the model is a neural network, and wherein the mediation parameters are variables inputted to at least one position of an input layer or a hidden layer of the neural network.

7. The model generation device according to claim 2, the one or more processors are further configured to output the learned model parameters for each source domain and the mediation parameter relevance information.

8. The model generation device according to claim 2, wherein the one or more processors are further configured to:
generate target model parameters which correspond to the target domain and include the mediation parameters, based on the plurality of learned model parameters for each source domain and the mediation parameter relevance information, and
determine the mediation parameters included in the target model parameters using the evaluation data of the target domain.

9. The model generation device according to claim 1 wherein the one or more processors are further configured to divide the learning data of a certain source domain to generate the learning data in the plurality of source domains.

10. The model generation device according to claim 1, wherein the one or more processors are further configured to apply data conversion processing to the learning data of a certain source domain to generate the learning data in the plurality of source domains.

11. The model generation device according to claim 10, wherein the data conversion processing generates variations corresponding to the difference in domains.

12. A model adjustment device comprising:
a memory storing instructions; and
one or more processors configured to execute the instructions to:
generate target model parameters which correspond to a target domain and include mediation parameters, based on learned model parameters for each of a plurality of source domains and mediation parameter relevance information indicating relevance between the learned model parameters and the mediation parameters; and
determine the mediation parameters included in the target model parameters using evaluation data of the target domain.

13. The model adjustment device according to claim 12, wherein the one or more processors are configured to perform performance evaluation using the evaluation data while changing values of the mediation parameters, and determine the values of the mediation parameters when a result of the performance evaluation is best as the values of the mediation parameters included in the target model parameters.

14. A model generation method comprising:
learning model parameters corresponding to a model to be used using learning data in a plurality of source domains; and
generating mediation parameter relevance information indicating relevance between the model parameters and mediation parameters.

15. A model adjustment method comprising:
generating target model parameters which correspond to a target domain and include mediation parameters, based on learned model parameters for each of a plurality of source domains and mediation parameter relevance information indicating relevance between the learned model parameters and the mediation parameters; and
determining the mediation parameters included in the target model parameters using evaluation data of the target domain.

16. A non-transitory computer-readable recording medium storing a program causing a computer
learn model parameters corresponding to a model to be used using learning data in a plurality of source domains; and
generate mediation parameter relevance information indicating relevance between the model parameters and mediation parameters.

17. A non-transitory computer-readable recording medium storing a program causing a computer to:
generate target model parameters which correspond to a target domain and include mediation parameters, based on learned model parameters for each of a plurality of source domains and mediation parameter relevance information indicating relevance between the learned model parameters and the mediation parameters; and
determine the mediation parameters included in the target model parameters using evaluation data of the target domain.
